(19) United States
(12) Patent Application Publication
(10) Pub. No.: US 2006/0291369 A1
(43) Pub. Date: Dec. 28, 2006

(54) Recorded master for manufacturing information storage medium and method of manufacturing the master

(76) Inventors: Du-Seop Yoon, Seongnam-si (KR); Jao-Ho Kim, Yongin-si (KR); In-Sik Park, Suwon-si (KR); In-Oh Hwang, Seongnam-si (KR); Hyun-Ki Kim, Kwaseong-si (KR)

Correspondence Address: STEIN, MCEWEN & BUI, LLP, 1400 EYE STREET, NW, SUITE 300, WASHINGTON, DC, 20005, US

(21) Appl. No.: 10/570,803

(22) PCT Filed: Sep. 1, 2004
(86) PCT No.: PCT/KR04/02198

§ 371 Date: Mar. 6, 2006

(30) Foreign Application Priority Data
Sep. 6, 2003 (KR) 10-2003-0062421
Mar. 17, 2004 (KR) 10-2004-0018002

(51) Int. Cl. G11B 3/70

(52) U.S. Cl. 369/288

(57) ABSTRACT

A recorded master for manufacturing an information storage medium includes a master substrate; a heat absorption layer coated on the master substrate and absorbing heat at a part on which a beam is irradiated; and a separation layer coated on the heat absorption layer, wherein according to a temperature distribution of the part on which the beam is irradiated on the heat absorption layer, a volume change occurs in at least one of the heat absorption layer and the separation layer.

### CROSS-REFERENCE TO RELATED APPLICATIONS

This application claims the benefit of PCT International Patent Application No. PCT/KR2004/002198, filed Sep. 1, 2004, Korean Patent Application No. 2004-18002, filed Mar. 17, 2004, and Korean Patent Application No. 2003-62421, filed Sep. 6, 2003 in the Korean Intellectual Property Office, the disclosures of which are incorporated herein by reference.

### BACKGROUND OF THE INVENTION

1. Field of the Invention

An aspect of the present invention relates to a recorded master for manufacturing an information storage medium and a method of manufacturing the master, and more particularly, to a recorded master for manufacturing an information storage medium in which a pit or groove of a very small size can be formed by chemical and physical reactions between thin films and a stamper can be easily separated by a separation layer, and a method of manufacturing the master.

2. Description of the Related Art

Generally, an information storage medium is widely employed as an information recording medium in an optical pickup apparatus for recording and/or reproducing information contactlessly. Optical discs as information storage media, are divided into a compact disc (CD), and a digital versatile disc (DVD) according to the information recording capacity. Optical discs capable of recording, deleting and reproducing information include a 650 MB CD-R, CD-RW, 4.7 GB DVD+RW, and so on. Furthermore, an HD-DVD with a recording capacity of 20 GB or over is also under development.

Thus, information storage media are being developed with the purpose of increasing a recording capacity. Representative methods for increasing a recording capacity include shortening the wavelength of a recording light source and increasing the numerical aperture of an object lens. Another method for increasing recording capacity includes forming a recording layer having multiple layers.

Meanwhile, a pit or groove is formed on a substrate on any type of information storage media. Another method of increasing a recording capacity of the information storage media includes reducing the pit size or track pitch of a groove.

Capacities of information storage media, pit sizes, and track pitches by generation are shown in the following Table 1:

TABLE 1

| | 1st generation | 2nd generation | 3rd generation |
|---|---|---|---|
| Spec name | CD | DVD | BD |
| Capacity | 650 MB | 4.7 GB | 25 GB |
| Laser wavelength | 780 nm | 650 nm | 405 nm |
| Object lens | 0.45 | 0.6 | 0.85 |
| numerical aperture | | | |
| Minimum pit size | 0.83 μm | 0.40 μm | 0.16 μm |
| Track pitch | 1.6 μm | 0.74 μm | 0.32 μm |

As shown in Table 1, with the increasing recording capacity, the pit size and track pitch decrease and technologies to make the pit size and track pitch much smaller are being developed. Here, BD indicates a blu-ray disc.

Meanwhile, FIG. 1 is a flowchart illustrating a conventional process of manufacturing an information storage medium. The process of manufacturing an information storage medium can be broadly divided into a mastering process and a disc making process. The mastering process is a process for making a stamper from which substrates are injection molded. In the mastering process, a photoresist is coated on a glass substrate in operation S10, and exposure is performed by irradiating a laser beam on the photoresist according to a signal corresponding to a mark to be recorded in operation S12. Then, by developing the photoresist-coated substrate, a recorded master is made in operation S14, and an electrode layer is formed on the glass substrate by Ni sputtering in operation S16. Then, metal coating is performed in operation S18. On the recorded master, pit shapes and groove shapes are formed.

Next, the metal coated layer is separated from the recorded master to form a stamper in operation S20.

By using the stamper, a substrate is injection molded in operation S22. Then, by sputtering, a recording film is laminated on the injection molded substrate in operation S24, and a cover layer is laminated on the recording film in operation S26. Through this process, a disc is manufactured in operation S28.

In the manufacturing process, the recording operation S12 by irradiating a laser beam can be regarded as one of the most important factors determining a pit size and a track pitch. When the size of the pit or the track pitch is to be reduced to increase a recording capacity, the spot size of a laser beam should be reduced. That is, by reducing the wavelength of a laser beam and increasing the numerical aperture, the spot size of a laser beam can be reduced.

### SUMMARY OF THE INVENTION

However, the wavelength of the laser beam and the numerical aperture have limitations and thus achieving even higher density and higher capacity recording in discs beyond the generation of the blu-ray disc (BD) is difficult. Accordingly, a method using an electronic beam having a short wavelength instead of a laser beam are being newly researched and developed. Thus, new research and development is necessary to satisfy the high density and high capacity recording requirement.

An aspect of the present invention provides a recorded master for manufacturing an information storage medium in which the size of a pit and a size of a track pitch of a groove can be easily reduced without the need to make a wavelength of a laser beam shorter. According to another aspect of the present invention, there is provided a separate layer allowing a metal coated layer for a stamper to be separated from a master, simplifying a manufacturing process, and allowing the implementation of high density and high capacity recording. According to another aspect of the present invention, a method of manufacturing the master, is provided.

According to another aspect of the present invention, there is provided a recorded master for manufacturing an information storage medium including: a master substrate; a heat absorption layer which is coated on the master substrate and absorbs heat at a part on which a beam is irradiated; and a separation layer which is coated on the heat absorption layer, wherein according to the temperature distribution of the part on which the beam is irradiated, volume change occurs in at least one of the heat absorption layer and the separation layer.

According to an aspect of the present invention, the separation layer may be formed of a photoresist.

According to an aspect of the present invention, the heat absorption layer is formed of an alloy layer.

According to an aspect of the present invention, the alloy layer may be formed of a rare earth element metal and a transition metal.

According to an aspect of the present invention, the alloy layer may be formed of TbFeCo.

According to an aspect of the present invention, a dielectric layer may be included on at least one of the top and bottom of the heat absorption layer.

According to an aspect of the present invention, the heat absorption layer may be formed as an alloy dielectric layer formed of a dielectric and an alloy.

According to an aspect of the present invention, when the melting point of the heat absorption layer is T1 and the part on which a laser beam is irradiated has a temperature of 0.5T1 or greater, a volume change may occur in the heat absorption layer and the separation layer part.

According to an aspect of the present invention, when the melting point of the heat absorption layer is T1, the melting point of the separation layer is T2, and the temperature distribution of the part on which a laser beam is irradiated is equal to or greater than T2 and lower than 0.5T1, volume change may occur in the separation layer such that a pit is formed.

According to an aspect of the present invention, when the melting point of the separation layer is T2, the glass transition temperature of the separation layer is T3, and the temperature distribution of the part on which a laser beam is irradiated is equal to or higher than T3 and lower than T2, a volume change may occur in the separation layer such that a bump is formed.

According to another aspect of the present invention, there is provided a method of fabricating a recorded master for manufacturing an information storage medium including: coating a heat absorption layer which absorbs heat at a part on a master substrate on which a beam is irradiated; coating a separation layer on the heat absorption layer; and by irradiating a laser beam on the heat absorption layer, causing volume change in at least one of the heat absorption layer and the separation layer with respect to the temperature distribution of a part on which the beam is irradiated.

According to the recorded master for manufacturing an information storage medium of an aspect of the present invention, by disposing a heat absorption layer and a separation layer in which the volumes change when the layers are heated over a predetermined temperature, a pit or a bump is formed such that the size of the pit (or bump) or track pitch can be reduced. By doing so, a high density and high capacity information storage medium can be realized without implementing a high numerical aperture of an object lens and a short wavelength of a laser beam.

Furthermore, separation of a stamper from a master can be easily performed and a stamper with a low surface roughness can be provided by using the recorded master according to an aspect of the present invention. Also, according to the temperature distribution of a part on which a laser beam is irradiated, a pit or a bump can be selectively formed by volume transformation in a heat absorption layer or in a separation layer. In particular, when a pit or a bump is formed by a volume transformation in the separation layer, the depth of the pit or bump can be restricted to the thickness of the separation layer such that the shape of the pit or bump can be easily controlled.

In addition, the method of manufacturing a recorded master for manufacturing an information storage medium according to an aspect of the present invention can be performed by using the conventional mastering equipment without change such that the manufacturing cost is low and by using a laser beam of an identical wavelength, the size of a pit or track pitch can be greatly reduced. Also, the stamper can be easily separated from the heat absorption layer such that the manufacturing process can be simplified.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a conventional method of manufacturing an information storage medium;

FIG. 2 is a diagram showing the layer structure of a recorded master for manufacturing an information storage medium according to an aspect of the present invention;

FIG. 3 is a diagram showing a state in which a laser beam is irradiated to a recorded master for manufacturing an information storage medium according to an aspect of the present invention;

FIG. 4 is a diagram showing a state in which a volume change occurs in a heat absorption layer employed in a recorded master for manufacturing an information storage medium according to an aspect of the present invention;

FIG. 5 is a diagram showing a state in which a volume change occurs in a separation layer employed in a recorded master for manufacturing an information storage medium according to an aspect of the present invention such that a pit is formed;

FIG. 6 is a diagram showing a state in which a volume change occurs in a separation layer employed in a recorded master for manufacturing an information storage medium according to an aspect of the present invention such that a bump is formed;

FIG. 7A is a photo showing an example in which a volume change occurs in a separation layer employed in a recorded master for manufacturing an information storage medium according to an aspect of the present invention such that a pit is formed;

FIG. 7B is a photo showing an example in which a volume change occurs in a separation layer employed in a recorded master for manufacturing an information storage medium according to an aspect of the present invention such that a bump type groove is formed;

FIG. 8A is a diagram showing a state in which a coated metal layer is formed on a recorded master for manufacturing an information storage medium according to an aspect of the present invention;

FIG. 8B is a diagram showing a state in which a coated metal layer is separated from a recorded master for manufacturing an information storage medium according to an aspect of the present invention; and

FIG. 9 is a flowchart illustrating a mastering process of a recorded master for manufacturing an information storage medium according to an aspect of the present invention.

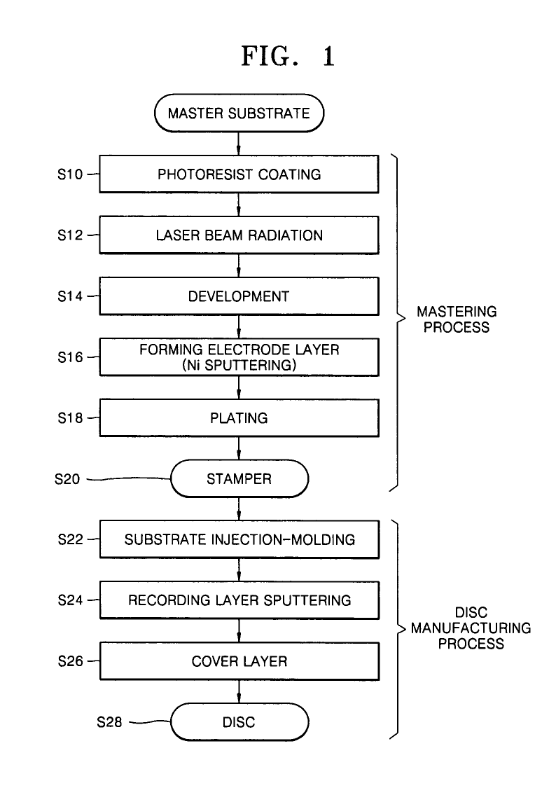

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

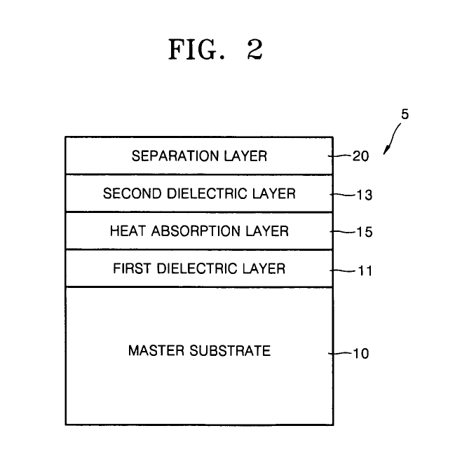

Referring to FIG. 2, a recorded master 5 for manufacturing an information storage medium according to an aspect of the present invention includes a heat absorption layer 15 coated on a master substrate 10, and a separation layer 20 coated on the heat absorption layer 15.

The heat absorption layer 15 absorbs heat when a beam is irradiated, thereon and a volume change occurs in the part on which the beam is irradiated, or volume change occurs in the separation layer 20. That is, in the heat absorption layer 15, a chemical and physical reaction occurs according to temperature distribution and causes a volume change in the heat absorption layer 15 itself, or causes a volume change only in the separation layer 20.

The heat absorption layer 15 can be formed as an alloy dielectric layer, which is formed of a dielectric and an alloy, or an alloy layer. Here, the alloy (or the alloy layer) can be formed by including rare earth element metals and transition metals, and the rare earth element metals include Tb and the transition metals may include Fe and Co.

A dielectric layer can be disposed on at least one of the top and bottom of the heat absorption layer 15. FIG. 2 shows a case where a first dielectric layer 11 and a second dielectric layer 13 are disposed on the top and bottom of the heat absorption layer 15, respectively.

The first and second dielectric layers 11 and 13 can be formed by including a mixture of ZnS and SiO₂. Preferably, the heat absorption layer is formed of TbFeCo and the first and second dielectric layers 11 and 13 can be formed of ZnS—SiO₂.

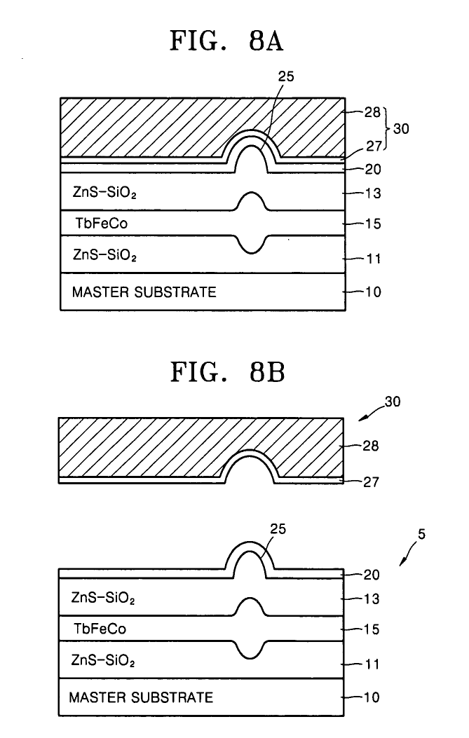

The separation layer 20 is laminated on the heat absorption layer 15 such that a stamper (refer to element 30 of FIG. 8A) to be explained later can be easily separated from the heat absorption layer 15. The separation layer 20 can be formed of, for example, photoresist. Also, due to the volume change in the heat absorption layer 15, the volume of the separation layer 20 may change with the heat absorption layer 15, or may change alone.

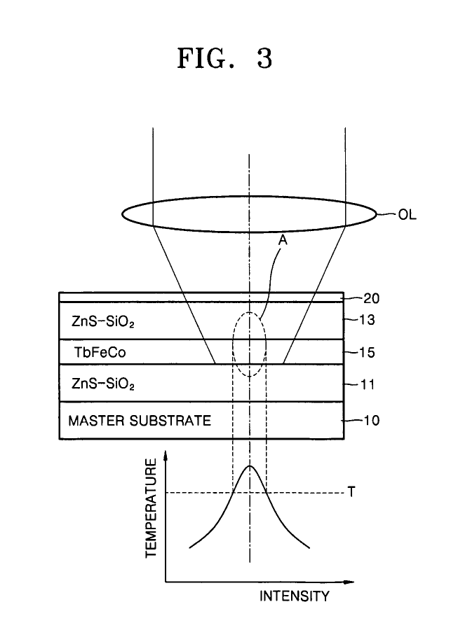

Referring to FIG. 3, since a laser beam (L) has a Gaussian distribution, the optical intensity of the central part is relatively stronger than the edge part of the laser beam. Accordingly, if a laser beam is irradiated on the heat absorption layer 15, the temperature of an area on which the central part of the laser beam is irradiated becomes higher than that of an area on which the edge part of the laser beam is irradiated. The laser beam (L) is focused on the heat absorption layer 15 through an object lens (OL).

While the recorded master 5 rotates, the laser beam (L) is irradiated on the recorded master 5. At this time, the temperature distribution of an exposed part at the heat absorption layer 15 changes with respect to the linear velocity of the recorded master 5 and the power of the laser beam. According to this temperature distribution, a volume change occurs in at least one of the heat absorption layer 15 and the separation layer 20.

Assuming that the melting point of the heat absorption layer 15 is T1, the melting point of the separation layer 20 is T2, and the glass transition temperature of the separation layer 20 is T3, if the heat absorption layer 15 is heated up to a temperature in the vicinity of T1, the reaction of the heat absorption layer 15 and dielectric layers causes a volume transformation in the heat absorption layer 15 and according to this volume transformation, a transformation occurs also in the first and second dielectric layers 11 and 13 and the separation layer 20.

When a recording condition causing a transformation is simulated, a temperature in which forming of a protrusion part is possible is equal to or greater than 0.5T1.

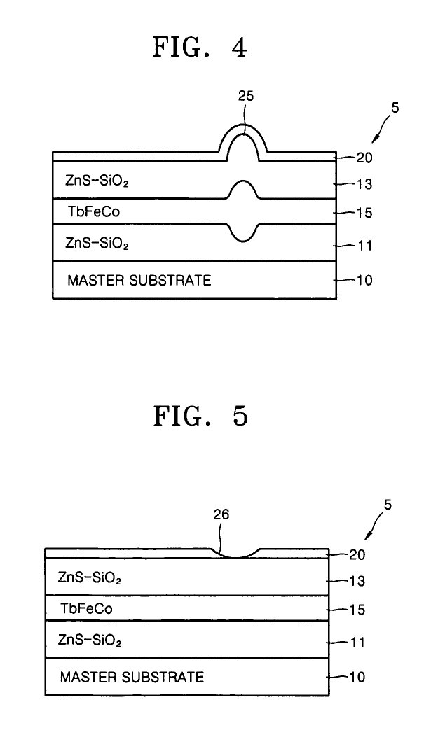

In other words, a volume change occurs in the part (A) of the heat absorption layer 15 heated up to the vicinity of a predetermined temperature (T1), and a protrusion part 25 as shown in FIG. 4 is formed. This protrusion part 25 becomes a bump or a groove. Hereinafter, a bump will be referred to by reference number 25.

Next, when the temperature of a part on which a beam is irradiated is substantially lower than T1, the reaction between thin films does not occur. Accordingly, as shown in FIG. 5, a volume transformation occurs not in the heat absorption layer 15, but only in the separation layer 20 such that a pit 26 is formed. Here, the temperature of a part on which a beam is, irradiated is heated up to a temperature equal to or over T2 and lower than 0.5T1, and a pit 26 is formed.

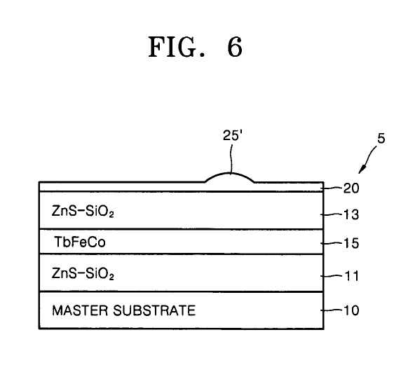

Meanwhile, if the temperature of a part on which a beam is irradiated is equal to or higher than T3 and lower than T2, as shown in FIG. 6, volume transformation occurs in the separation layer 20 such that a bump 25′ is formed. Also at this time, a volume transformation occurs not in the heat absorption layer 15, but occurs only in the separation layer 20. While the pit 26 is formed in FIG. 5, a bump 25′ is formed in FIG. 6. When the pit 26 or the bump 25′ is formed by the volume transformation in the separation layer 20, the depth of the pit 26 or the height of the bump 25′ is limited to the thickness of the separation layer 20. Accordingly, there is an advantage in that the height or depth does not need to be controlled separately.

As described above, with respect to the temperature of a part on which a beam is irradiated, layers where a volume transformation occurs and the shape of volume transformation change.

More specifically, a heat absorption layer formed of TbFeCo of a 15 nm thickness, a dielectric layer of a 15 nm thickness, and a separation layer formed of photoresist of a 50 nm thickness are sequentially laminated on a master substrate and information is recorded by irradiating a laser beam. Here, the glass transition temperature of the photoresist is 110-130° C., the melting point of the photoresist is 200-220° C., and the melting point of TbFeCo layer is approximately 1440° C.

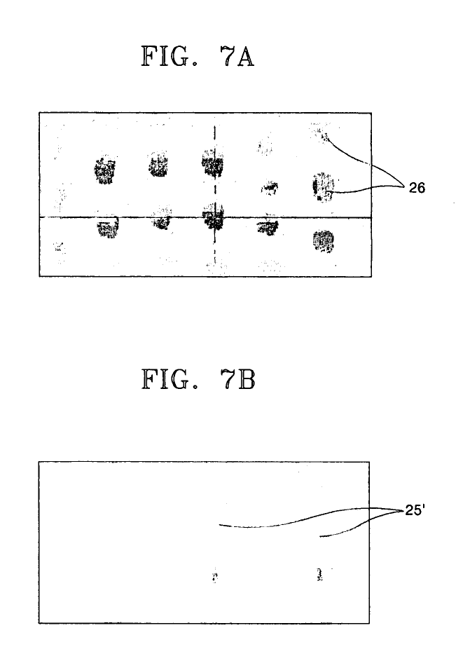

At this time, data was recorded using a laser beam having a 405 nm wavelength, 10 MHz pulse, and 13 mW recording power, and a recording condition of a 6 m/sec linear velocity, and a photo of the result is shown in FIG. 7A. According to the photo, a pit 26 is formed in a separation layer and the depth is 30 nm that is the thickness of the photoresist. Also, the size of the pit formed at this time is approximately 150 nm. This size cannot be manufactured by the conventional mastering method. Under the conditions described above, it is difficult to measure the temperature of a part on which a laser beam was irradiated, but according to temperature calculation by simulation, the temperature is approximately 400° C.

Next, when the linear velocity is 6 m/sec and the recording power is 10 mW, the temperature of an exposed part is approximately 200° C., and in this temperature distribution, a bump (25′) type groove is formed as shown in FIG. 7B.

As shown in FIG. 8A, an electrode layer 27 is laminated on the separation layer 20 and a metal coated layer 28 is formed. Then, as shown in FIG. 8B, the electrode layer 27 and the metal coated layer 28 are separated from the master 5. Thus, the separated electrode layer 27 and the metal coated layer 28 become a stamper 30.

At this time, using a solution capable of melting only the separation layer 20 not affecting the metal coated layer 28, the stamper 30 can be easily separated.

For example, when the separation layer 20 is formed of a photoresist, separation can be easily performed by melting the photoresist.

When the stamper 30 is separated form the separation layer 20, the separation layer 20 may not be removed completely and part of the separation layer 20 may remain on the second dielectric layer 13 or on the electrode layer 27. However, even when part of the separation layer 20 remains on either side, the photoresist can be removed easily such that there is no particular difficulty in the manufacturing process. Also, when the separation layer 20 is formed of, for example, a liquid photoresist, the surface of the separation layer 20 is very smooth and the surface shape of this separation layer 20 is directly transferred to the stamper 30. Accordingly, there is an advantage in that the surface roughness of the stamper 30 is greatly reduced.

Though the pit 26 formed by the volume transformation in the heat absorption layer 15 is shown in FIGS. 8A and 8B, the method of manufacturing a stamper is identical even when the bump 25′ is formed.

Thus, the stamper 30 required for injection molding a substrate of an information storage medium is completed. If a substrate is injection molded by using this stamper, the shape of a pit, groove or bump is transferred on the substrate. By sequentially laminating a recording film and a cover layer on this substrate, an information storage medium is manufactured.

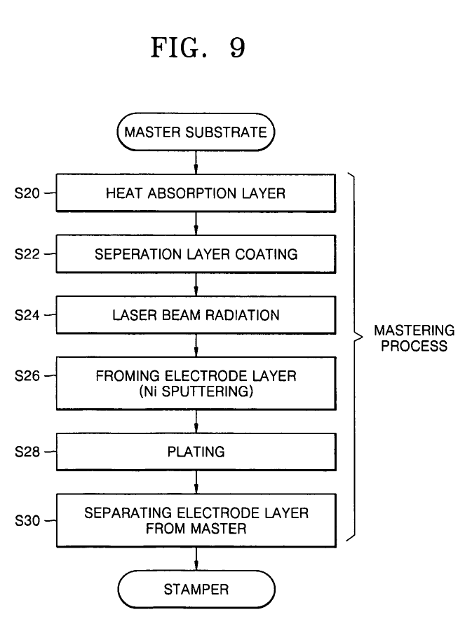

Next, referring to FIGS. 2 and 9, in a method of manufacturing a recorded master for manufacturing an information storage medium, the heat absorption layer 15 is coated on the master substrate 10 in operation S20 and the separation layer 20 is coated on the heat absorption layer 15 in operation S22.

The heat absorption layer 15 has a characteristic that when the heat absorption layer 15 is heated over a predetermined temperature, a physical and chemical reaction occurs. According to the temperature distribution of a part on which a beam is irradiated, volume transformation occurs in at least one of the heat absorption layer 15 and the separation layer 20 and a pit or a bump is formed.

The temperature of the part on which a beam is irradiated depends on the power of a laser beam or the linear velocity of the master.

As described above, the heat absorption layer 15 is formed of the first dielectric layer 11, the alloy layer, and the second dielectric layer 13, or formed as an alloy dielectric layer.

Preferably, the alloy layer 12 is formed of a rare earth element metal and a transition metal, and the rare earth element metal includes Tb and the transition metal includes iron (Fe) and cobalt (Co).

If a laser beam is irradiated on the heat absorption layer 15 in operation S24, a part which is heated up over a predetermined temperature on which the laser beam is irradiated swells and a pit (or groove) or a bump is formed. Here, since the laser beam has a Gaussian distribution, the size of the part which is heated up over the predetermined temperature and swells can be minimized. That is, when a laser beam of an identical wavelength and an object lens of an identical numerical aperture are used, a valid spot size of a laser beam can be reduced compared to the conventional manufacturing method. Here, the valid spot size means a spot size which is practically used to form a pit.

Though a laser beam is irradiated after the separation layer 20 is coated on the heat absorption layer 15 in the above explanation, a laser beam may be irradiated on the heat absorption layer 15 before laminating the separation layer 20 on the heat absorption layer 15 to form a pit or a groove, and then the separation layer 20 can be coated on the heat absorption layer 15. This method is applied when a volume transformation occurs in the heat absorption layer 15.

Then, the electrode layer 27 for metal coating is formed on the separation layer 20 in operation S26, and using the electrode layer 27, the metal coated layer 28 is formed in operation S28. Then, the bump (or groove) 25 or 25′ or the pit 26 formed by volume transformation in at least one of the heat absorption layer 15 and the separation is transferred.

Next, by removing the separation layer 20, the electrode layer 27 and the metal coated layer 28 are separated from the master 5. When the separation layer 20 is formed by a photoresist, it can be easily removed from the master 5. By doing so, the stamper 30 for injection molding a substrate can be obtained in operation S30.

Depending on whether or not a pit shape remains on the second dielectric layer 13 when the separation layer 20 is removed, it can be confirmed whether volume transformation occurs in the heat absorption layer or the separation layer 20.

Meanwhile, by varying the thicknesses of the heat absorption layer and the separation layer, the effects of those layers were tested. Here, the first and second dielectric layers 11 and 13 formed of ZnS—SiO₂ and the alloy layer formed of TbFeCo were coated on the glass substrate 10 by sputtering and the separation layer 20 was formed by spin coating positive type photoresist. Then, the thicknesses of the first and second dielectric layers 11 and 13, the alloy layer and the separation layer 20 were transformed as shown in table 2:

TABLE 2

| | | Thickness (nm) | | | |
|---|---|---|---|---|---|
| | | sample | sample | sample | sample |
| | | 1 | 2 | 3 | 4 |
| 1st dielectric | ZnS—SiO₂ | 170 | 170 | 170 | 170 |
| layer | | | | | |
| Alloy layer | TbFeCo | 15 | 15 | 15 | 15 |
| 2nd dielectric | ZnS—SiO₂ | 15 | 15 | 15 | 15 |
| layer | | | | | |
| Photoresist | Positive type | 0 | 25 | 50 | 100 |

On the substrate prepared as illustrated in Table 2, a blue laser was irradiated and a pulse of 15 MHz was input as a recording signal at a linear velocity of 3 m/sec. After recording by irradiating a laser beam, an electrode layer was spread to a thickness of approximately 100 nm by sputtering, and a stamper was formed by metal coating. After metal coating, whether or not the stamper was separated (separation) was confirmed, and after making the stamper, the depth of a pit was measured. Separation of the stamper was performed mainly between the separation layer and the electrode layer. When a small amount of the separation layer remained on the stamper, it could be easily removed by NaOH aqueous solution.

The test result of the depths of pits formed by varying the thickness of the heat absorption layer and the separation layer as in Table 2 and separation are shown in Table 3:

TABLE 3

| Sample Number | Pit depth (nm) | Separation |
|---|---|---|
| 1 | 65 | Not separated |
| 2 | 60 | Separable |
| 3 | 50 | Separable |
| 4 | 30 | Separable |

According to the results in Table 3, when there was no separation layer (sample 1), it was impossible to separate the stamper from the heat absorption layer, and accordingly, it can be seen that the stamper cannot be manufactured normally.

Meanwhile, when there was the separation layer, it can be seen that separation of the stamper is possible regardless of the thickness of the separation layer.

Thus by simply coating the separation layer on the heat absorption layer, the stamper for manufacturing an information storage medium can be easily manufactured.

Although a few embodiments of the present invention have been shown and described, it would be appreciated by those skilled in the art that changes may be made in this embodiment without departing from the principles and spirit of the invention, the scope of which is defined in the claims and their equivalents.

1. A recorded master for manufacturing an information storage medium comprising:
a master substrate;
a heat absorption layer which is coated on the master substrate and absorbs heat irradiated from a beam; and
a separation layer which is coated on the heat absorption layer,
wherein according to a temperature distribution of a part on which the beam is irradiated, volume change occurs in at least one of the heat absorption layer and the separation layer.

2. The recorded master of claim 1, wherein the separation layer is formed of a photoresist.

3. The recorded master of claim 1, wherein the heat absorption layer is formed of an alloy layer.

4. The recorded master of claim 3, wherein the alloy layer is formed of a rare earth element metal and a transition metal.

5. The recorded master of claim 4, wherein the alloy layer is formed of TbFeCo.

6. The recorded master of claim 1, further comprising a dielectric layer on at least one of top and bottom surfaces of the heat absorption layer.

7. The recorded master of claim 6, wherein the dielectric layer is formed of a mixture of ZnS and SiO₂.

8. The recorded master of claim 1, wherein the heat absorption layer is formed as an alloy dielectric layer formed of a dielectric and an alloy.

9. The recorded master of claim 1, wherein when a melting point of the heat absorption layer is T1 and the part on which the beam is irradiated on the heat absorption layer has a temperature of 0.5T1 or higher, a volume change occurs in the heat absorption layer and the separation layers.

10. The recorded master of claim 1, wherein when a melting point of the heat absorption layer is T1, a melting point of the separation layer is T2, and the temperature distribution of the part on which the beam is irradiated on the heat absorption layer is equal to or higher than T2 and lower than 0.5T1, a volume change occurs in the separation layer and a pit is formed.

11. The recorded master of claim 1, wherein when a melting point of the separation layer is T2, a glass transition temperature of the separation layer is T3, and the temperature distribution of the part on which the beam is irradiated on the heat absorption layer is equal to or higher than T3 and lower than T2, volume change occurs in the separation layer and a bump is formed.

12. A method of fabricating a recorded master for manufacturing an information storage medium, comprising:
coating a heat absorption layer on a master substrate, the heat absorption layer absorbing heat at a portion on which a beam is irradiated;
coating a separation layer on the heat absorption layer; and
by irradiating a laser beam on the heat absorption layer causing a volume change in at least one of the heat absorption layer and the separation layer with respect to a temperature distribution of a part on which the laser beam is irradiated.

13. The method of claim 12, wherein the separation layer is formed of a photoresist.

14. The method of claim 12, wherein the heat absorption layer is formed of an alloy layer.

15. The method of claim 14, wherein the alloy layer is formed of a rare earth element metal and a transition metal.

16. The method of claim 15, wherein the alloy layer is formed of TbFeCo.

17. The method of claim 12, wherein a dielectric layer is included on at least one of the top and bottom of the heat absorption layer.

18. The method of claim 17, wherein the dielectric layer is formed of a mixture of ZnS and SiO₂.

19. The method of claim 12, wherein the heat absorption layer is formed as an alloy dielectric layer formed of a dielectric and an alloy.

20. The method of claim 12, wherein when a melting point of the heat absorption layer is T1 and the part of the heat absorption layer on which the laser beam is irradiated has a temperature of 0.5T1 or higher, a volume change occurs in the heat absorption layer and the separation layer part.

21. The method of claim 12, wherein when a melting point of the heat absorption layer is T1, a melting point of the separation layer is T2, and the temperature distribution of the part on which the laser beam is irradiated is equal to or higher than T2 and lower than 0.5T1, a volume change occurs in the separation layer and a pit is formed.

22. The method of claim 12, wherein when a melting point of the separation layer is T2, a glass transition temperature of the separation layer is T3, and the temperature distribution of the part on which the laser beam is irradiated is equal to or higher than T3 and lower than T2, a volume change occurs in the separation layer and a bump is formed.

23. The method of claim 12, wherein the temperature of a part on which a beam is irradiated depends on the power of the beam and the linear velocity of the master.
